(19) United States
(12) Patent Application Publication
(10) Pub. No.: US 2024/0396798 A1
(43) Pub. Date: Nov. 28, 2024

(54) USER-SPECIFIC NETWORK CONFIGURATION MANAGEMENT

(71) Applicant: International Business Machines Corporation, Armonk, NY (US)

(72) Inventors: Utpal Mangla, Toronto (CA); Shikhar Kwatra, San Jose, CA (US); Mathews Thomas, Flower Mound, TX (US); Juel Daniel Raju, Garland, TX (US); Aaron K. Baughman, Cary, NC (US)

(73) Assignee: International Business Machines Corporation, Armonk, NY (US)

(21) Appl. No.: 17/951,869

(22) Filed: Sep. 23, 2022

(51) Int. Cl. H04L 41/0823; H04L 41/147; H04L 41/16

(52) U.S. Cl. CPC H04L 41/0823; H04L 41/147; H04L 41/16

(57) ABSTRACT

A network usage plan is constructed using a network usage prediction model. The network usage plan comprises a first time and a first desired network configuration to be implemented at the first time. A network is configured according to the first desired network configuration for use at the first time. Responsive to determining, during a time period in which the network is configured according to the first network configuration, that a usage requirement has changed more than a threshold amount, the network is reconfigured according to a second network configuration meeting the changed usage requirement.

### BACKGROUND

The present invention relates generally to a method, system, and computer program product for network configuration management. More particularly, the present invention relates to a method, system, and computer program product for user-specific network configuration management.

Telecommunications networks have typically offered all customers, or all customers who pay for a particular set of services, the same network configuration. For example, in 2G, 3G, and 4G cellular communications networks, each device is typically subject to the same service level requirements, for example minimum bandwidth and latency levels. In contrast, 5G communications networks currently being deployed, and future networks being defined, support network slicing, a network architecture that supports multiple virtualized, independent logical networks on the same physical network infrastructure. Each network slice is a virtual network that is capable of supporting particular bandwidth, security, or other service requirements, and is reconfigurable and scalable. Multiple slices operate on top of a common physical network infrastructure. In one network architecture framework, a service layer manages service instances, which describe required network characteristics in the form of service requirements that are expected to be fully satisfied by a network slice. A network function layer creates and manages network slices according to service instance requests coming from the service layer. An infrastructure layer provides the physical network resources (e.g., radio access network, transport network and core network) upon which every network slice is multiplexed.

### SUMMARY

The illustrative embodiments provide a method, system, and computer program product. An embodiment includes a method that constructs, using a network usage prediction model, a network usage plan, the network usage plan comprising a first time and a first desired network configuration to be implemented at the first time. An embodiment configures, for use at the first time, a network according to the first desired network configuration, the configuring resulting in a first network configuration. An embodiment reconfigures, responsive to determining, during a time period in which the network is configured according to the first network configuration, that a usage requirement has changed more than a threshold amount, the network according to a second network configuration, the second network configuration meeting the changed usage requirement.

An embodiment includes a computer usable program product. The computer usable program product includes one or more computer-readable storage devices, and program instructions stored on at least one of the one or more storage devices.

An embodiment includes a computer system. The computer system includes one or more processors, one or more computer-readable memories, and one or more computer-readable storage devices, and program instructions stored on at least one of the one or more storage devices for execution by at least one of the one or more processors via at least one of the one or more memories.

### BRIEF DESCRIPTION OF THE DRAWINGS

Certain novel features believed characteristic of the invention are set forth in the appended claims. The invention itself, however, as well as a preferred mode of use, further objectives and advantages thereof, will best be understood by reference to the following detailed description of the illustrative embodiments when read in conjunction with the accompanying drawings, wherein:

FIG. 1 depicts an example diagram of a data processing environments in which illustrative embodiments may be implemented;

FIG. 2 depicts a block diagram of an example configuration for user-specific network configuration management in accordance with an illustrative embodiment;

FIG. 3 depicts an example of user-specific network configuration management in accordance with an illustrative embodiment;

FIG. 4 depicts a flowchart of an example process for user-specific network configuration management in accordance with an illustrative embodiment;

### DETAILED DESCRIPTION

The illustrative embodiments recognize that current telecommunications networks do not offer network customization on a per-user or per-device basis. Instead, while current telecommunications networks are reconfigurable (e.g., to redistribute traffic among access points while an access point is experiencing a failure or being repaired), the reconfiguration applies to all devices, or all devices in a particular customer category, with access to the network. However, network slicing supports an ability to offer network customization on a per-user or per-device basis, and thus there is a need to implement user-specific network customization and network configuration management.

The illustrative embodiments recognize that the presently available tools or solutions do not address these needs or provide adequate solutions for these needs. The illustrative embodiments used to describe the invention generally address and solve the above-described problems and other problems related to user-specific network configuration management.

An embodiment can be implemented as a software application. The application implementing an embodiment can be configured as a modification of an existing network configuration management system, as a separate application that operates in conjunction with an existing network configuration management system, a standalone application, or some combination thereof.

Particularly, some illustrative embodiments provide a method that uses a network usage prediction model to construct a network usage plan, configures a network according to the network usage plan, and reconfigures, responsive to determining, during a time period in which the network is configured according to the first desired network configuration, that a usage requirement has changed more than a threshold amount, the first desired network configuration into a second desired network configuration.

An embodiment receives user-specific data. One non-limiting example of user-specific data is data of a user's network usage, such as how much traffic a user's device sends to and receives from a network, the device's usage times, and the device's location. For example, User A might spend her workday using one of her devices to participate in virtual meetings using video, necessitating a particular data transfer rate and constant network connectivity, while User B might spend her workday interacting with others in person and only uses her device for the occasional email or text, requiring a lower data transfer rate over a network that need not be available at all times. However, User A is typically offline during the evenings, while User B uses her device to watch streaming video in the evenings. Another non-limiting example of user-specific data is data a user provides or allows access to, such as a user's calendar, email data, social media data, location data, and the like. Another non-limiting example of user-specific data is data of a user's role that might impact the user's networking needs. For example, User C might be a firefighter, requiring access to a dedicated communications capability for first responders when on duty.

An embodiment analyzes user-specific data to derive one or more usage patterns, and uses the usage patterns and data of a user's upcoming activities (if available) to construct a network usage prediction model. Techniques to derive a usage pattern and construct a usage prediction model based on the pattern and other data are presently available. In one embodiment, the network usage prediction model is specific to a particular user. For example, User A has an established usage pattern of virtual video meetings from 9 to 5 on workdays, and very little device usage in the evenings. However, User A's calendar and social media activity indicate that she will be spending next week bicycling in France on vacation. Thus, next week User A is unlikely to require the network capacity required to participate in her typical video meetings. As another example, User C's duty schedule indicates that she works 24 hour shifts every third day, except for a week next month when she will be on vacation, and a network usage prediction model for User C reflects both her duty schedule and upcoming vacation. As a third example, User D has just been added to a workgroup that conducts a video meeting every workday morning at 9 am, and her calendar data indicates this. Thus, a network usage prediction model for User D indicates that she will require sufficient network capacity to participate in a video meeting every workday morning between 9 and 9:30 am. In another embodiment, the network usage prediction model is specific to a particular group of users sharing similar characteristics. Another embodiment, if there is insufficient user-specific data to construct a user-specific network usage prediction model, modifies a default network usage prediction model into a user-specific network usage prediction model as the embodiment gathers additional user-specific data.

An embodiment uses a network usage prediction model to construct a network usage plan. The network usage plan includes a time and a desired network configuration to be implemented at the time. For example, because the network usage prediction model for User D indicates that she will require sufficient network capacity to participate in a video meeting every workday morning between 9 and 9:30 am, the network usage plan for User D might specify one desired network configuration—sufficient network capacity to participate in a video meeting—Mondays through Fridays from 9 to 9:30 am, and a second desired network configuration—enough network capacity for email, texting, and website access, but not for two-way video—during other times. As another example, the network usage plan for User C, the firefighter, might specify one desired network configuration—the dedicated communications capability for first responders—during her on-duty hours, and a second desired network configuration, without access to the dedicated communications capability, during other times. In one embodiment, the network usage plan is specific to a particular user. In another embodiment, the network usage plan is specific to a particular group of users sharing similar characteristics. Techniques for using a prediction model to construct a plan are presently known.

An embodiment manages a plurality of stored network configurations, also called containers. The stored network configurations are predefined network configurations that are usable as starting points when configuration a network in accordance with a specific network usage plan. For example, one stored network configuration might support participation in a two-way virtual meeting, another stored network configuration might support sufficient download throughput for streaming video but a slower upload throughput, and a third stored network configuration might support sufficient throughput for email and texting only. One embodiment also stores an encoding corresponding to a stored network configuration, for use in computing configuration similarity.

An embodiment configures a network according to a network usage plan. In particular, an embodiment uses the desired network configuration specified in a network usage plan for a particular time to configure the network accordingly. For example, if the network usage plan for User D specifies a desired network configuration—sufficient network capacity to participate in a video meeting—Mondays through Fridays from 9 to 9:30 am, an embodiment configures a network for User D's use according to the desired network configuration in time for Monday morning at 9 am. At 9:30 am or later, the embodiment reconfigures User D's network into a second desired network configuration—enough network capacity for email, texting, and website access, but not for two-way video. As another example, because the network usage plan for User C, the firefighter, specifies a desired network configuration—the dedicated communications capability for first responders—between noon Monday and noon Tuesday (her on-duty hours), an embodiment configures a network for User C's use according to the desired network configuration in time for noon on Monday.

One embodiment configures the network as specified in the desired network configuration. For example, if the plan specifies particular amounts of upload and download bandwidth and use of a particular network access point, the embodiment configures the network to provide the specified amounts of upload and download bandwidth using the specified network access point.

Another embodiment configures the network according to a stored network configuration that is most similar to the desired network configuration. To compute similarity between configurations, one embodiment uses a trained model to convert each configuration into a corresponding encoding, a multidimensional number. The model is trained, using a presently known technique, to produce encodings such that similarity between configurations can be measured by computing similarity between corresponding encodings. For example, one presently known similarity measure, cosine similarity, treats encodings as vectors and computes the cosine of the angle between two vectors. Other techniques for computing similarity between network configurations are also possible and contemplated within the scope of the illustrative embodiments. Another embodiment configures the network according to a stored network configuration that is most similar to the desired network configuration as long as the similarity between the most similar stored network configuration and the desired network configuration is also above a threshold value.

Another embodiment configures the network according to a combination of stored network configurations that are most similar to the desired network configuration. In particular, an embodiment selects, from a plurality of stored network configurations, a plurality of most similar stored network configurations. Each stored network configuration in the plurality of most similar stored network configurations has above a threshold similarity with the desired network configuration. The embodiment merges the plurality of most similar stored network configurations into a merged network configuration. To generate a merged network configuration, one embodiment uses a deep neural network (DNN). The desired network configuration and the most similar stored network configurations are inputs to the DNN, and the DNN is trained to incorporate portions of the most similar stored network configurations that best implement the desired network configuration. A DNN is an artificial neural network with more than one layer between the network's input and output layers. Another embodiment uses another presently available technique to generate a merged network configuration.

An embodiment monitors usage of the configured network relative to the network usage plan. An embodiment also receives additional user and network data.

If an embodiment determines that a user's usage requirement has changed more than a threshold amount, an embodiment reconfigures the network into a second network configuration that meets the usage requirement. For example, an embodiment might determine, from User E's usage of the network, that User E is participating in an unscheduled virtual meeting using two-way video. Thus, User E requires a network configuration fast enough to support two-way video, and because the meeting was unscheduled User E's current network configuration is not fast enough. Thus, an embodiment reconfigures User E's network into a configuration that is fast enough to support two-way video. As another example, an embodiment might determine, from additional user and network data, that User C, the firefighter, has been called in to respond to an emergency even though she is off duty. Thus, an embodiment reconfigures User C's network into the dedicated communications capability for first responders. As a third example, suppose User B upgrades the device she uses to watch streaming video to a new device that supports a higher video resolution than before. Thus, User B needs additional network capability to support the higher video resolution when she watches streaming video, and an embodiment determines that User B's device is requires data at the higher resolution and reconfigures User B's network into a configuration that supports the higher video resolution.

An embodiment uses usage of the configured network relative to the network usage plan, as well as additional user and network data, to update the network usage prediction model and optionally the network usage plan. For example, now that User B has an upgraded device supporting a higher video resolution, she will likely continue to require the higher video resolution. Thus, an embodiment updates User B's network usage prediction model and the network usage plan to specify the higher video resolution. As another example, an embodiment determines that User C's duty hours have changed, or that User D has a new regularly scheduled video meeting, and updates their network usage prediction model and network usage plans accordingly.

If an embodiment determines that a second user interacting with a user has a network configuration that is more than a threshold amount below the user's requirements, an embodiment reconfigures the second user's network into a network configuration that meets the usage requirement. For example, Users A and F are interacting in a virtual meeting over two-way video. Because User A spends her whole workday in such video meetings, User A's network configuration is already sufficient to support two-way video. However, User F does not routinely participate in such video meetings, and thus her current network configuration is more than a threshold amount below User A's requirements for a successful meeting. Thus, an embodiment reconfigures User F's network into a network configuration that does support two-way video.

The manner of user-specific network configuration management described herein is unavailable in the presently available methods in the technological field of endeavor pertaining to network configuration management. A method of an embodiment described herein, when implemented to execute on a device or data processing system, comprises substantial advancement of the functionality of that device or data processing system in using a network usage prediction model to construct a network usage plan, configuring a network according to the network usage plan, and reconfiguring, responsive to determining, during a time period in which the network is configured according to the first desired network configuration, that a usage requirement has changed more than a threshold amount, the first desired network configuration into a second desired network configuration.

The illustrative embodiments are described with respect to certain types of network configurations, usage plans, usage requirements, usage data, user data, network data, thresholds, adjustments, sensors, measurements, devices, data processing systems, environments, components, and applications only as examples. Any specific manifestations of these and other similar artifacts are not intended to be limiting to the invention. Any suitable manifestation of these and other similar artifacts can be selected within the scope of the illustrative embodiments.

Furthermore, the illustrative embodiments may be implemented with respect to any type of data, data source, or access to a data source over a data network. Any type of data storage device may provide the data to an embodiment of the invention, either locally at a data processing system or over a data network, within the scope of the invention. Where an embodiment is described using a mobile device, any type of data storage device suitable for use with the mobile device may provide the data to such embodiment, either locally at the mobile device or over a data network, within the scope of the illustrative embodiments.

The illustrative embodiments are described using specific code, designs, architectures, protocols, layouts, schematics, and tools only as examples and are not limiting to the illustrative embodiments. Furthermore, the illustrative embodiments are described in some instances using particular software, tools, and data processing environments only as an example for the clarity of the description. The illustrative embodiments may be used in conjunction with other comparable or similarly purposed structures, systems, applications, or architectures. For example, other comparable mobile devices, structures, systems, applications, or architectures therefor, may be used in conjunction with such embodiment of the invention within the scope of the invention. An illustrative embodiment may be implemented in hardware, software, or a combination thereof.

The examples in this disclosure are used only for the clarity of the description and are not limiting to the illustrative embodiments. Additional data, operations, actions, tasks, activities, and manipulations will be conceivable from this disclosure and the same are contemplated within the scope of the illustrative embodiments.

Any advantages listed herein are only examples and are not intended to be limiting to the illustrative embodiments. Additional or different advantages may be realized by specific illustrative embodiments. Furthermore, a particular illustrative embodiment may have some, all, or none of the advantages listed above.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

### Characteristics are as Follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

### Service Models are as Follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

### Deployment Models are as Follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

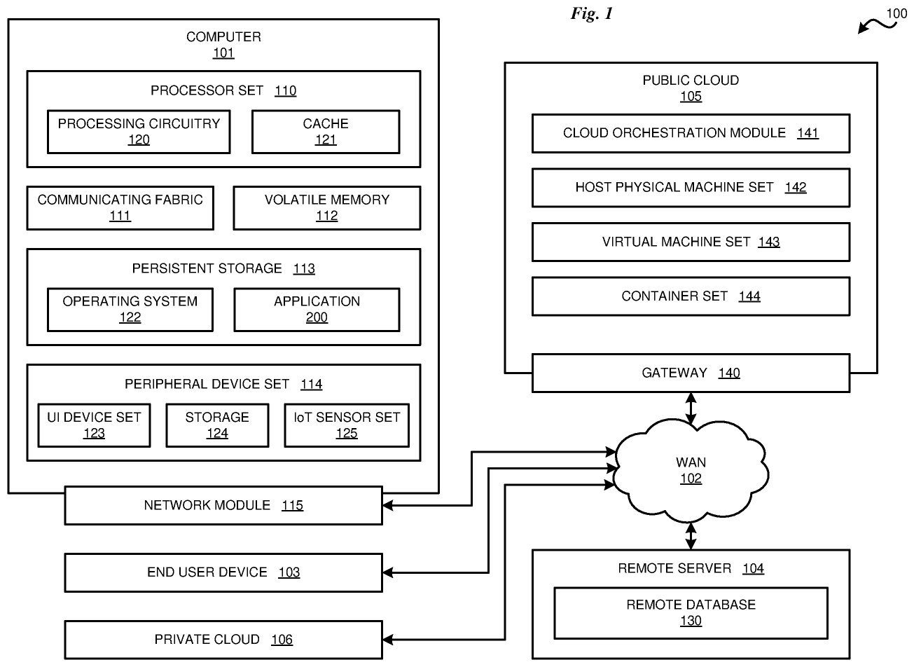

With reference to the figures and in particular with reference to FIG. 1, this figure is an example diagram of a data processing environments in which illustrative embodiments may be implemented. FIG. 1 is only an example and are not intended to assert or imply any limitation with regard to the environments in which different embodiments may be implemented. A particular implementation may make many modifications to the depicted environments based on the following description. FIG. 1 depicts a block diagram of a network of data processing systems in which illustrative embodiments may be implemented. Computing environment 100 contains an example of an environment for the execution of at least some of the computer code involved in performing the inventive methods, such as application 200. Application 200 implements a user-specific network configuration management embodiment described herein. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144. Application 200 executes in any of computer 101, end user device 103, remote server 104, or a computer in public cloud 105 or private cloud 106 unless expressly disambiguated. Further, application 200, when executed, reconfigures a configuration of WAN 102 or another network (not depicted).

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processor set 110 may contain one or more processors and may be implemented using one or more heterogeneous processor systems. A processor in processor set 110 may be a single- or multi-core processor or a graphics processor. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Operating system 122 runs on computer 101. Operating system 122 coordinates and provides control of various components within computer 101. Instructions for operating system 122 are located on storage devices, such as persistent storage 113, and may be loaded into at least one of one or more memories, such as volatile memory 112, for execution by processor set 110.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods of application 200 may be stored in persistent storage 113 and may be loaded into at least one of one or more memories, such as volatile memory 112, for execution by processor set 110. The processes of the illustrative embodiments may be performed by processor set 110 using computer implemented instructions, which may be located in a memory, such as, for example, volatile memory 112, persistent storage 113, or in one or more peripheral devices in peripheral device set 114. Furthermore, in one case, application 200 may be downloaded over WAN 102 from remote server 104, where similar code is stored on a storage device. In another case, application 200 may be downloaded over WAN 102 to remote server 104, where downloaded code is stored on a storage device.

Communication fabric 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in application 200 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, user interface (UI) device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. Internet of Things (IoT) sensor set 125 is made up of sensors that can be used in IoT applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

Wide area network (WAN) 102 is any WAN (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

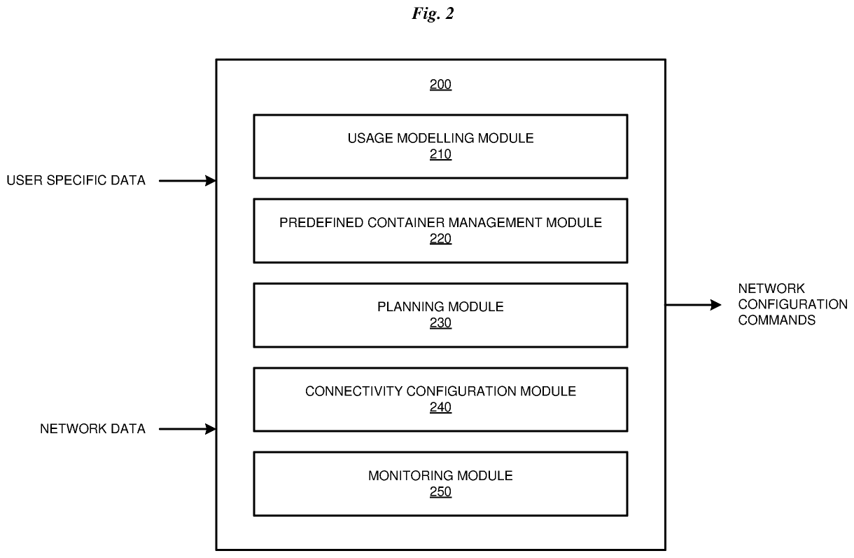

With reference to FIG. 2, this figure depicts a block diagram of an example configuration for user-specific network configuration management in accordance with an illustrative embodiment. Application 200 is the same as application 200 in FIG. 1.

Application 200 receives user-specific data, such as data of a user's network usage (e.g. how much traffic a user's device sends to and receives from a network, the device's usage times, and the device's location), data a user provides or allows access to (e.g. a user's calendar, email data, social media data, location data, and the like), and data of a user's role that might impact the user's networking needs.

Usage modelling module 210 analyzes user-specific data to derive one or more usage patterns, and uses the usage patterns and data of a user's upcoming activities (if available) to construct a network usage prediction model. In one implementation of module 310, the network usage prediction model is specific to a particular user. In another implementation of module 310, the network usage prediction model is specific to a particular group of users sharing similar characteristics. Another implementation of module 310, if there is insufficient user-specific data to construct a user-specific network usage prediction model, modifies a default network usage prediction model into a user-specific network usage prediction model as the implementation gathers additional user-specific data.

Predefined container management module 220 manages a plurality of stored network configurations, also called containers. The stored network configurations are predefined network configurations that are usable as starting points when configuration a network in accordance with a specific network usage plan. One implementation of module 220 also stores an encoding corresponding to a stored network configuration, for use in computing configuration similarity.

Planning module 230 uses a network usage prediction model to construct a network usage plan. The network usage plan includes a time and a desired network configuration to be implemented at the time. In one implementation of module 230, the network usage plan is specific to a particular user. In another implementation of module 230, the network usage plan is specific to a particular group of users sharing similar characteristics.

Connectivity configuration module 240 configures a network according to a network usage plan. In particular, module 240 uses the desired network configuration specified in a network usage plan for a particular time to configure the network accordingly.

One implementation of module 240 configures the network as specified in the desired network configuration.

Another implementation of module 240 configures the network according to a stored network configuration that is most similar to the desired network configuration. To compute similarity between configurations, one implementation of module 240 uses a trained model to convert each configuration into a corresponding encoding, a multidimensional number. The model is trained, using a presently known technique, to produce encodings such that similarity between configurations can be measured by computing similarity between corresponding encodings. For example, one presently known similarity measure, cosine similarity, treats encodings as vectors and computes the cosine of the angle between two vectors. Another implementation of module 240 configures the network according to a stored network configuration that is most similar to the desired network configuration as long as the similarity between the most similar stored network configuration and the desired network configuration is also above a threshold value.

Another implementation of module 240 configures the network according to a combination of stored network configurations that are most similar to the desired network configuration. In particular, module 240 selects, from a plurality of stored network configurations, a plurality of most similar stored network configurations. Each stored network configuration in the plurality of most similar stored network configurations has above a threshold similarity with the desired network configuration. Module 240 merges the plurality of most similar stored network configurations into a merged network configuration. One implementation of module 240 uses a DNN to merge the plurality of most similar stored network configurations into a merged network configuration. In particular, the desired network configuration and the most similar stored network configurations are inputs to the DNN, and the DNN is trained to incorporate portions of the most similar stored network configurations that best implement the desired network configuration.

Monitoring module 250 monitors usage of the configured network relative to the network usage plan. Monitoring module 250 also receives additional user and network data.

If module 250 determines that a user's usage requirement has changed more than a threshold amount, module 250 reconfigures the network into a second network configuration that meets the usage requirement.

Application 200 uses usage of the configured network relative to the network usage plan, as well as additional user and network data, to update the network usage prediction model and optionally the network usage plan.

If module 250 determines that a second user interacting with a user has a network configuration that is more than a threshold amount below the user's requirements, module 250 reconfigures the second user's network into a network configuration that meets the usage requirement.

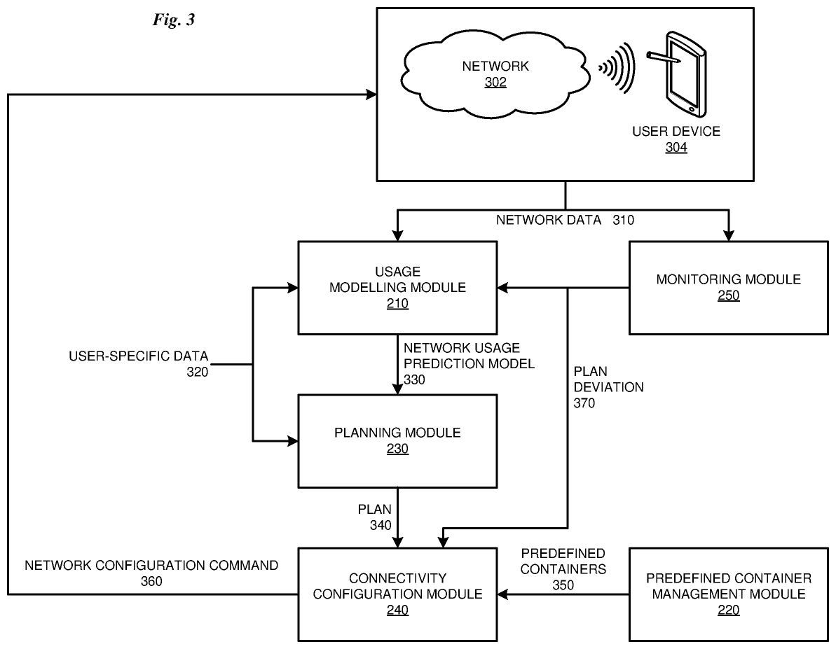

With reference to FIG. 3, this figure depicts an example of user-specific network configuration management in accordance with an illustrative embodiment. Usage modelling module 210, predefined container management module 220, planning module 230, connectivity configuration module 240, and monitoring module 250 are the same as usage modelling module 210, predefined container management module 220, planning module 230, connectivity configuration module 240, and monitoring module 250 in FIG. 3.

As depicted, usage modelling module 210 and monitoring module 250 receive network data 310. Network data 310 is data of network 302 and user device 304 (using network 302).

Usage modelling module 210 analyzes user-specific data 320 (data of the user associated with user device 304) to derive one or more usage patterns, and uses the usage patterns and data of a user's upcoming activities (if available) to construct network usage prediction model 330.

Planning module 230 uses network usage prediction model 330 to construct a network usage plan 340. Plan 340 includes a time and a desired network configuration to be implemented at the time.

Connectivity configuration module 240 configures a network according to plan 340. In particular, module 240 uses the desired network configuration specified in plan 340 for a particular time to configure network 302 for user device 304 accordingly, using network configuration command 360. One implementation of module 240 configures network 302 for user device 304 as specified in the desired network configuration. Another implementation of module 240 configures network 302 for user device 304 according to one of predefined containers 350, in particular the stored network configuration that is most similar to the desired network configuration. Another implementation of module 240 configures network 302 for user device 304 according to a combination of predefined containers 350, stored network configurations that are most similar to the desired network configuration.

Monitoring module 250 uses network data 310 to determine plan deviation 370. If module 250 uses plan deviation 370 to reconfigure network 302 into a second network configuration that meets the usage requirement, via network configuration command 360. Module 250 also communicates plan deviation 370 to module 210, for use in updating the network usage prediction model and optionally the network usage plan.

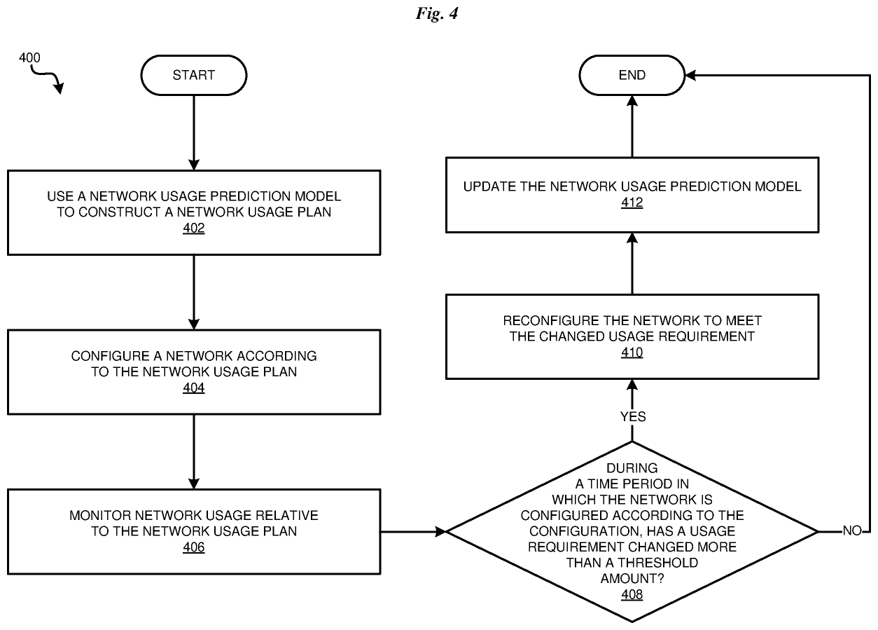

With reference to FIG. 4, this figure depicts a flowchart of an example process for user-specific network configuration management in accordance with an illustrative embodiment. Process 400 can be implemented in application 200 in FIG. 2.

In block 402, the application uses a network usage prediction model to construct a network usage plan. In block 404, the application configures a network according to the network usage plan. In block 406, the application monitors network usage relative to the network usage plan. In block 408, the application determines, during a time period in which the network is configured according to the configuration, whether a usage requirement has changed more than a threshold amount. If yes (“YES” path of block 408), in block 410 the application reconfigures the network to meet the changed usage requirement. In block 412, the application updates the network usage prediction model. Then (also “NO” path of block 408) the application ends.

Thus, a computer implemented method, system or apparatus, and computer program product are provided in the illustrative embodiments for user-specific network configuration management and other related features, functions, or operations. Where an embodiment or a portion thereof is described with respect to a type of device, the computer implemented method, system or apparatus, the computer program product, or a portion thereof, are adapted or configured for use with a suitable and comparable manifestation of that type of device.

Where an embodiment is described as implemented in an application, the delivery of the application in a Software as a Service (SaaS) model is contemplated within the scope of the illustrative embodiments. In a SaaS model, the capability of the application implementing an embodiment is provided to a user by executing the application in a cloud infrastructure. The user can access the application using a variety of client devices through a thin client interface such as a web browser (e.g., web-based e-mail), or other light-weight client-applications. The user does not manage or control the underlying cloud infrastructure including the network, servers, operating systems, or the storage of the cloud infrastructure. In some cases, the user may not even manage or control the capabilities of the SaaS application. In some other cases, the SaaS implementation of the application may permit a possible exception of limited user-specific application configuration settings.

The present invention may be a system, a method, and/or a computer program product at any possible technical detail level of integration. The computer program product may include a computer readable storage medium (or media) having computer readable program instructions thereon for causing a processor to carry out aspects of the present invention.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

1. A computer-implemented method comprising:
constructing, using a usage pattern and data of a future scheduled activity, a network usage prediction model;
constructing, using the network usage prediction model, a network usage plan, the network usage plan comprising a first time and a first desired network configuration to be implemented at the first time;
configuring, for use at the first time, a network according to the first desired network configuration, the configuring resulting in a first network configuration; and
reconfiguring, responsive to determining, during a time period in which the network is configured according to the first network configuration, that a usage requirement has changed more than a threshold amount, the network according to a second network configuration, the second network configuration meeting the changed usage requirement.

2. The computer-implemented method of claim 1, wherein the network usage plan is specific to a user.

3. The computer-implemented method of claim 1, wherein the first network configuration is specific to a user.

4. The computer-implemented method of claim 1, wherein configuring, for use at the first time, a network according to the first desired network configuration comprises:
selecting, from a plurality of stored network configurations, a plurality of most similar stored network configurations, each stored network configuration in the plurality of most similar stored network configurations have above a threshold similarity with the first desired network configuration;
merging, into a merged network configuration, the plurality of most similar stored network configurations; and
configuring, according to the merged network configuration, the network.

5. The computer-implemented method of claim 4, wherein merging, into a merged network configuration, the plurality of most similar stored network configurations is performed using a deep neural network.

6. The computer-implemented method of claim 1, further comprising:
reconfiguring, responsive to determining, during the time period, that a second usage requirement of a second user has changed more than a threshold amount, a network configuration of the second user to a second network configuration of the second user, the second network configuration of the second user meeting the second changed usage requirement.

7. The computer-implemented method of claim 1, further comprising:
updating, based on the changed user requirement, the network usage plan.

8. A computer program product comprising one or more computer readable storage medium, and program instructions collectively stored on the one or more computer readable storage medium, the program instructions executable by a processor to cause the processor to perform operations comprising:
constructing, using a usage pattern and data of a future scheduled activity, a network usage prediction model;
constructing, using the network usage prediction model, a network usage plan, the network usage plan comprising a first time and a first desired network configuration to be implemented at the first time;
configuring, for use at the first time, a network according to the first desired network configuration, the configuring resulting in a first network configuration; and
reconfiguring, responsive to determining, during a time period in which the network is configured according to the first network configuration, that a usage requirement has changed more than a threshold amount, the network according to a second network configuration, the second network configuration meeting the changed usage requirement.

9. The computer program product of claim 8, wherein the stored program instructions are stored in a computer readable storage device in a data processing system, and wherein the stored program instructions are transferred over a network from a remote data processing system.

10. The computer program product of claim 8, wherein the stored program instructions are stored in a computer readable storage device in a server data processing system, and wherein the stored program instructions are downloaded in response to a request over a network to a remote data processing system for use in a computer readable storage device associated with the remote data processing system, further comprising:
program instructions to meter use of the program instructions associated with the request; and
program instructions to generate an invoice based on the metered use.

11. The computer program product of claim 8, wherein the network usage plan is specific to a user.

12. The computer program product of claim 8, wherein the first network configuration is specific to a user.

13. The computer program product of claim 8, wherein configuring, for use at the first time, a network according to the first desired network configuration comprises:
selecting, from a plurality of stored network configurations, a plurality of most similar stored network configurations, each stored network configuration in the plurality of most similar stored network configurations have above a threshold similarity with the first desired network configuration;
merging, into a merged network configuration, the plurality of most similar stored network configurations; and
configuring, according to the merged network configuration, the network.

14. The computer program product of claim 13, wherein merging, into a merged network configuration, the plurality of most similar stored network configurations is performed using a deep neural network.

15. The computer program product of claim 8, further comprising:
reconfiguring, responsive to determining, during the time period, that a second usage requirement of a second user has changed more than a threshold amount, a network configuration of the second user to a second network configuration of the second user, the second network configuration of the second user meeting the second changed usage requirement.

16. The computer program product of claim 8, further comprising:
updating, based on the changed user requirement, the network usage plan.

17. A computer system comprising a processor and one or more computer readable storage media, and program instructions collectively stored on the one or more computer readable storage media, the program instructions executable by the processor to cause the processor to perform operations comprising:
constructing, using a usage pattern and data of a future scheduled activity, a network usage prediction model;
constructing, using the network usage prediction model, a network usage plan, the network usage plan comprising a first time and a first desired network configuration to be implemented at the first time;
configuring, for use at the first time, a network according to the first desired network configuration, the configuring resulting in a first network configuration; and
reconfiguring, responsive to determining, during a time period in which the network is configured according to the first network configuration, that a usage requirement has changed more than a threshold amount, the network according to a second network configuration, the second network configuration meeting the changed usage requirement.

18. The computer system of claim 17, wherein the network usage plan is specific to a user.

19. The computer system of claim 17, wherein the first network configuration is specific to a user.

20. The computer system of claim 17, wherein configuring, for use at the first time, a network according to the first desired network configuration comprises:
selecting, from a plurality of stored network configurations, a plurality of most similar stored network configurations, each stored network configuration in the plurality of most similar stored network configurations have above a threshold similarity with the first desired network configuration;
merging, into a merged network configuration, the plurality of most similar stored network configurations; and
configuring, according to the merged network configuration, the network.
